(19) United States
(12) Patent Application Publication
(10) Pub. No.: US 2019/0392591 A1
(43) Pub. Date: Dec. 26, 2019

(54) APPARATUS AND METHOD FOR DETECTING MOVING OBJECT USING OPTICAL FLOW PREDICTION

(71) Applicant: Electronics and Telecommunications Research Institute, Daejeon (KR)

(72) Inventors: Ji Won LEE, Daejeon (KR); Do Won NAM, Daejeon (KR); Sung Won MOON, Daejeon (KR); Jung Soo LEE, Sejong-si (KR); Won Young YOO, Daejeon (KR); Ki Song YOON, Daejeon (KR)

(73) Assignee: Electronics and Telecommunications Research Institute, Daejeon (KR)

(21) Appl. No.: 16/201,048

(22) Filed: Nov. 27, 2018

(30) Foreign Application Priority Data
Jun. 25, 2018 (KR) 10-2018-0072976
Oct. 22, 2018 (KR) 10-2018-0125977

(51) Int. Cl. G06T 7/269; G01V 8/10

(52) U.S. Cl. CPC G06T 7/269; G01V 8/10; G06T 2207/30224; G06T 2207/20081; G06T 2207/20084

(57) ABSTRACT

Disclosed herein is a method of detecting a moving object including: predicting an optical flow in an input image clip using a first deep neural network which is trained to predict an optical flow in an image clip including a plurality of frames; obtaining an optical flow image which reflects a result of the optical flow prediction; and detecting a moving object in the image clip on the basis of the optical flow image using a second deep neural network trained using the first deep neural network.

### CLAIM FOR PRIORITY

This application claims priority to Korean Patent Application No. 2018-0072976 filed on Jun. 25, 2018 and Korean Patent Application No. 2018-012597 filed on Oct. 22, 2018 in the Korean Intellectual Property Office (KIPO), the entire contents of which are hereby incorporated by reference.

### BACKGROUND

### 1. Technical Field

Example embodiments of the present invention relate to an apparatus and method for detecting a moving object which uses an optical flow prediction, and more specifically, to an apparatus and method for detecting a moving object which predicts an optical flow of an image using a deep neural network.

### 2. Related Art

In the worldwide sports image analysis market, growth of big companies, such as IBM and Oracle Corporation, and big data analysis companies, such as SAP, SAS, and OPTA, is remarkable due to development of an image analysis technology and a big data analysis technology. The market had already grown to $125 million in 2014 and $4.7 billion in 2017, and the market is expected to grow at a compound annual growth rate (CAGR) of 56.66% from 2017 to 2021.

In analyses of sports game images, a technology of detecting a ball in an image is a basic technology to trace the ball and recognize an event occurring in a game. However, it is generally very difficult to effectively detect a ball due to high speed, small size, and frequent hiding thereof.

Various techniques for detecting a ball in a game image have been proposed. First, there is a method using a Hough transform capable of detecting a circular shape in an image. This method may effectively detect a circular ball, but in the case of the ball which moves at a high speed, detection failures may occur frequently because there is a case in which an image of the ball is captured as an oval shape or is translucently captured. In addition, in a case in which a color of a ball is similar to a background color in a basketball game, this method of detecting a ball using a circumferential line thereof makes frequent mistakes.

As another method, in a method of detecting a ball using a filter, generally, the method selects candidates of a ball using a Kalman filter or particle filter and continuously detects an object having the highest similarity to the ball among the selected candidates. An accuracy of this method is high in a case in which a ball moves slowly like the above-described method, but in a case in which a speed of the ball is high, a detection failure occurs frequently.

In addition, there is a technique for predicting an optical flow of an image to recognize movement of an object. This method predicts a position of an object, which exists in the previous frame, in a following frame using a difference between frames of a moving image and calculates a value of an optical flow such that the value becomes higher as the difference becomes higher. This method is an effective technique for identifying a moving object and predicting a movement distance thereof. However, since there is a problem in that an amount of calculation increases as an image becomes larger, a calculation speed issue has to be solved to practically use this technique.

### SUMMARY

Accordingly, example embodiments of the present invention are provided to substantially obviate one or more problems due to limitations and disadvantages of the related art.

Example embodiments of the present invention provide an apparatus for detecting a moving object which predicts an optical flow of an image using a deep neural network.

Example embodiments of the present invention also provide a method of detecting a moving object by predicting an optical flow of an image using a deep neural network.

In some example embodiments, a method of detecting a moving object includes predicting an optical flow in an input image clip using a first deep neural network which is trained to predict an optical flow in an image clip including a plurality of frames, obtaining an optical flow image which reflects a result of the optical flow prediction, and detecting a moving object in the image clip on the basis of the optical flow image using a second deep neural network trained using the first deep neural network.

The image clip may include a sports image clip including a plurality of frames, and the optical flow may include optical flows in two directions which intersect each other.

Here, the first deep neural network may be trained through calculating an error value between the predicted optical flow and a calculated actual optical flow, propagating the error value back, and performing a gradient descent.

In addition, the predicting of the optical flow in the image clip may include predicting the optical flow using a difference between a first group image including a plurality of frames and a second group image including a plurality of frames, each of which directly follows a corresponding frame of the first group image over time by using the first deep neural network.

The first deep neural network may be trained through: predicting the optical flow using a difference between a first group image including a plurality of frames and a second group image including a plurality of frames, each of which directly follows a corresponding frame in the first group image; calculating an error value by comparing the predicted optical flow and an actual optical flow; and training an optical flow prediction deep neural network through propagating the error value back and performing a gradient descent.

The second deep neural network may be trained through labeling whether a ball exists in the optical flow image or a position of the ball therein and using the label as an input of the second deep neural network.

The first deep neural network may be trained such that the objective function has a minimum value by using a loss function to be applied to the first deep neural network as an objective function.

The second deep neural network may be trained such that the objective function has a minimum value by using a loss function to be applied to the second deep neural network as an objective function.

The first deep neural network may be formed by learning weights of edges between nodes of at least one hidden layer in the first deep neural network.

In other example embodiments, an apparatus for detecting a moving object includes a processor and a memory configured to store at least one command executed by the processor, wherein the at least one command includes a command for predicting an optical flow in an input image clip using a first deep neural network trained to predict an optical flow in an image clip including a plurality of frames, a command for obtaining an optical flow image which reflects a result of the optical flow prediction, and a command for detecting a moving object in the image clip on the basis of the optical flow image using a second deep neural network trained by using the first deep neural network.

The image clip may include a sports image clip including a plurality of frames, and the optical flow may include optical flows in two directions which intersect each other.

Here, the first deep neural network may be trained through calculating an error value between the predicted optical flow and a calculated actual optical flow, propagating the error value back, and performing a gradient descent.

The command to predict the optical flow in the input image clip may include a command for predicting the optical flow using a difference between a first group image including a plurality of frames and a second group image including a plurality of frames, each of which directly follows a corresponding frame of the first group image over time by using the first deep neural network.

The first deep neural network may be trained through predicting the optical flow using a difference between a first group image including a plurality of frames and a second group image including a plurality of frames, each of which directly follows a corresponding frame of the first group image, calculating an error value by comparing the predicted optical flow and an actual optical flow, and training the optical flow prediction deep neural network through propagating the error value and performing a gradient descent.

The second deep neural network may be trained through labeling whether a ball exists in the optical flow image or a position of the ball therein and using the label as an input of the second deep neural network.

The first deep neural network may be trained such that the objective function has a minimum value by using a loss function to be applied to the first deep neural network as an objective function.

The second deep neural network may be trained such that the objective function has a minimum value by using a loss function to be applied to the second deep neural network as an objective function.

The first deep neural network may be formed by learning weights of edges between nodes of at least one hidden layer in the first deep neural network.

### BRIEF DESCRIPTION OF DRAWINGS

Example embodiments of the present invention will become more apparent by describing example embodiments of the present invention in detail with reference to the accompanying drawings, in which:

FIG. 1 is a conceptual block diagram illustrating an apparatus for detecting a moving object according to one embodiment of the present invention;

FIG. 2 is a conceptual view illustrating a structure of a deep neural network applied to the present invention;

FIG. 3 is a table showing a configuration of an optical flow prediction deep neural network according to one embodiment of the present invention;

FIG. 4 is a view illustrating an input and an output of the optical flow prediction deep neural network according to one embodiment of the present invention;

FIG. 5 is a view illustrating one example of an optical flow image according to the present invention;

FIG. 6 is a table showing a configuration of a ball detection deep neural network according to one embodiment of the present invention;

FIG. 7 is a view illustrating an input and an output of the ball detection deep neural network for learning according to one embodiment of the present invention;

FIG. 8 is a flowchart of a method of detecting a moving object according to one embodiment of the present invention; and

FIG. 9 is a block diagram illustrating the apparatus for detecting a moving object according to one embodiment of the present invention.

### DESCRIPTION OF EXAMPLE EMBODIMENTS

As the invention allows for various changes and numerous embodiments, specific embodiments will be illustrated in the drawings and described in detail in the written description. However, this is not intended to limit the present invention to specific modes of practice, and it is to be appreciated that all changes, equivalents, and substitutes that do not depart from the spirit and technical scope of the present invention are encompassed in the present invention. Like numbers refer to like elements throughout the description of the drawings.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element without departing from the scope of the present invention. As used herein, the term “and/or” includes any one or a combination of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention has an objective of determining whether a ball exists in an image, which is captured by a camera, of a sports game which uses the ball, or of tracing a position of the ball in the image. Here, the sports game using the ball may refer to a sports game such as football, basketball, and baseball played using a ball. In a sports game, a ball generally moves at a high speed and rotates. Accordingly, the term “ball” may be interchangeable with terms “a moving object,” “a high speed moving object,” “a rotating and moving object,” and “a high speed rotating and moving object” in the specification.

Meanwhile, as described above, a problem of a conventional technology of recognizing a ball is that it is difficult to recognize the ball and react to the recognized ball in a case in which the ball moves quickly, and a recognition rate decreases in a case in which a color of the ball is similar to a color of a background.

Since this is an inevitable problem occurring in the conventional technology because recognition is attempted on the basis of a shape, a color, a size, and a feature of a ball, it is difficult to recognize the ball in a sports game image in which a speed and a moving direction of the ball are variously changed. In order to solve some of the problems, a method of recognizing a ball simultaneously using sensor apparatuses, such as radar, is also conventionally used, but there is a problem in that a kind of sports game that the sensing apparatuses can be used for is limited due to sizes and mobility of the sensor apparatuses. That is, the method may be limitedly applied to sports such as baseball and golf wherein a starting point and an ending point of a ball are clearly determined.

In order to overcome the problem, the present invention will use an optical flow to accurately recognize an object which moves at a high speed. This method has an advantage in that an object of interest may be stably identified even in a case in which a ball moves quickly, or a color of the ball is similar to that of a background. However, since calculation of the optical flow in the image requires a large amount of calculation, there is a disadvantage in that performance related to a speed of ball recognition is reduced.

Therefore, in the present invention, a method is proposed wherein a method of using an optical flow is used to attempt to recognize a ball, but the optical flow is not simply calculated when used. After a learning process is performed to predict the optical flow by using a deep neural network, the ball is recognized from the optical flow predicted through the learned deep neural network. By doing as described above, the problem of the conventional technology may be solved, and the optical flow may also be predicted quickly so that the ball can be recognized accurately and quickly.

Hereinafter, exemplary embodiments of the present invention will be described with reference to the accompanying drawings in detail.

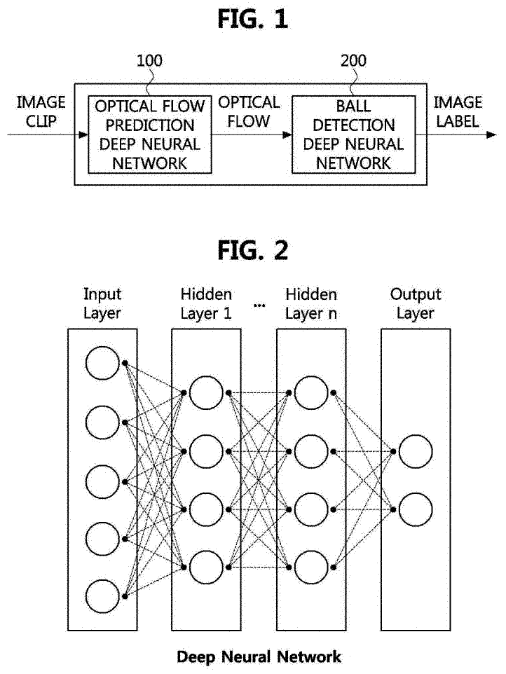

FIG. 1 is a conceptual block diagram illustrating an apparatus for detecting a moving object according to one embodiment of the present invention.

That is, FIG. 1 is the conceptual block diagram illustrating the apparatus for detecting a moving object which recognizes a ball in a sports game image according to one embodiment of the present invention. The apparatus for detecting a moving object according to one embodiment of the present invention may include an optical flow prediction deep neural network 100 and a ball detection deep neural network 200. In the present specification, the optical flow prediction deep neural network 100 may be referred to as a first deep neural network, and the ball detection deep neural network 200 may be referred as a second deep neural network.

The optical flow prediction deep neural network 100 may predict an optical flow, which means a moving direction and a movement distance of an object in an input sports game image. The ball detection deep neural network 200 may detect a ball object in a captured sports image on the basis of the predicted optical flow.

FIG. 2 is a conceptual view illustrating a structure of a deep neural network applied to the present invention.

The deep neural network is an artificial neural network (ANN) including multiple hidden layers interposed between an input layer and an output layer. The ANN may be implemented as the form of hardware in which a plurality of neurons, which are fundamental computing units, are connected through weighted links but is mainly implemented as computer software.

As illustrated in FIG. 2, in the deep neural network including the multiple hidden layers, various non-linear relationships may be learned. In one embodiment of the present invention, learning for rapidly predicting an optical flow of a moving object may be performed using the deep neural network including the multiple hidden layers.

According to an algorithm, the deep neural network may include a deep belief network (DBN), a deep autoencoder, or the like, which are based on an unsupervised learning method, a convolutional neural network (CNN) for a two-dimensional data process or a recurrent neural network (RNN) for a time series data process.

In one embodiment of the present invention, the deep neural network using the CNN is used to detect a moving object in a sports image.

In the present invention, two deep neural networks are used to classify an image clip. In the present invention, after the optical flow prediction deep neural network which is the first deep neural network is trained, the ball detection deep neural network which is the second deep neural network is trained using the trained first deep neural network. A process of training two deep neural networks will be described in detail below.

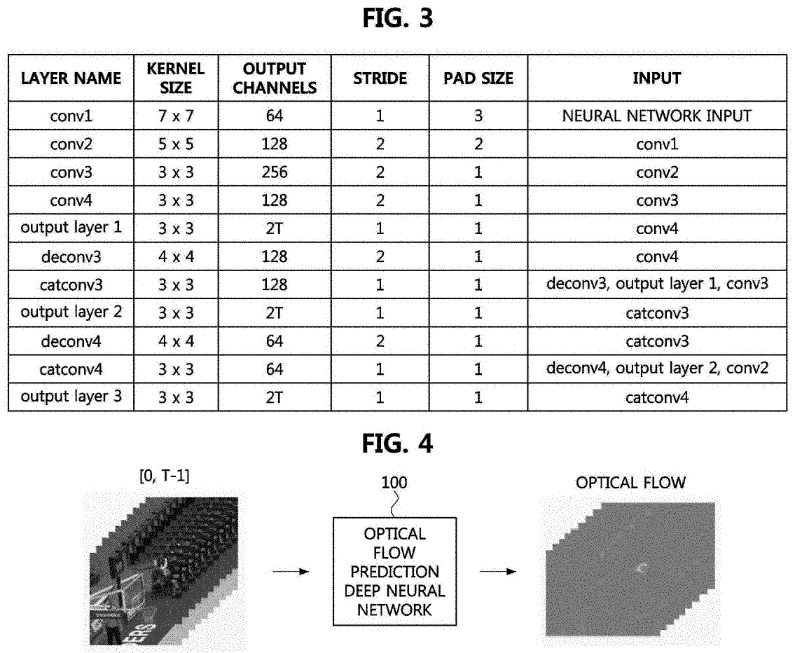

FIG. 3 is a table showing a configuration of the optical flow prediction deep neural network according to one embodiment of the present invention.

Referring to FIG. 3, conv*, that is, conv1, conv2, conv3, or conv4, is a name of a convolutional layer, and deconv*, that is, deconv1, deconv2, deconv3, or deconv4, is a name of a deconvolutional layer. In addition, catconv* (for example, catconv3 or catconv4) refers to a combination of a tensor channel concatenation layer and a convolutional layer, and output layer * (for example, an output layer 1, an output layer 2, or an output layer 3) refers to an output layer.

Here, a kernel is a common parameter for finding a feature of an image and also is referred to as a filter. A size of the kernel may be generally defined as a square matrix such as 7×7, 5×5, 3×3, or the like. A learning target of a neural network is a kernel parameter, and the neural network operates through a method of repeatedly accessing input data at a predetermined time interval to calculate a sum of convolutions between the filter and an input to obtain a feature map. That is, the kernel repeatedly accesses the input data at the predetermined time interval to calculate the convolutions with the input data, and here, a time interval in which the kernel is accessed is referred to as a stride.

Meanwhile, a size of the feature map may be smaller than that of the input data due to actions of the kernel and the stride in the convolutional layer. Here, a method of preventing reduction of an output data of the convolutional layer is a padding method. The padding means that predetermined pixels at a periphery of the input data are filled with a specific value, and each of the pixels is generally filled with zero which is a padding value. A size of a pad may refer to the number of pixels or a size of an area in which the padding has to be performed.

Meanwhile, LeakyReLU (slope=0.1) may be used as a non-linearity function of the convolutional layer.

The configuration of the optical flow prediction deep neural network illustrated in FIG. 3 is only one embodiment, and the configuration of the optical flow prediction deep neural network according to the present invention is not limited thereto. Weights of edges between nodes (vertexes) of the hidden layers inside the neural network are learned on the basis of an input image and a result of an actual optical flow in the deep neural network designed like FIG. 3. The deep neural network which has learned through the above process may predict an optical flow which is similar to the actual optical flow and is faster than calculating the actual optical flow.

FIG. 4 is a view illustrating an input and an output of the optical flow prediction deep neural network according to one embodiment of the present invention.

A training method of the optical flow prediction deep neural network will be described with reference to FIG. 4.

The optical flow prediction deep neural network 100 according to one embodiment of the present invention receives a sports image clip, which is an input, including, for example, T number of frames in order to predict an optical flow from the input image clip.

The optical flow prediction deep neural network 100 classifies the input image clip having the frames 0 to T−1 into two groups. One group is a set of the frames 0 to T−2 and may be referred to as a first group image. Another group is a set of the frames 1 to T−1 and may be referred to as a second group image.

The optical flow prediction deep neural network generates optical flows in x-axis and y-axis directions using the first group image and the second group image. In other words, when a first frame is followed by a second frame and the second frame is followed by a third frame over time, the optical flow of the corresponding image may be predicted on the basis of a changed value of the second group image from the first group image. Accordingly, when the image clip including T frames is input, an output of the optical flow prediction deep neural network may be an optical flow image having T−1 frames.

According to one embodiment of the present invention, the predicted optical flow and a calculated actual optical flow are compared to obtain an error value, and the error value is back propagated to train the optical flow prediction deep neural network through a gradient descent. Here, equations for calculating the error value are referred to as a loss function and may be defined the following Equations 1.

[Equations 1]

$${L}_{pix} ( k ) = \frac{1}{N} {\sum }_{i , j}^{N} f ( {I}_{1} ( i , j ) - {I}_{2} ( i + {O}_{i , j}^{x} ( k ) , j + {O}_{i , j}^{y} ( k ) ) ) \\ {L}_{x} ( k ) = f ( ∇ {O}_{x}^{x} ( k ) ) + f ( ∇ {O}_{y}^{x} ( k ) ) + f ( ∇ {O}_{x}^{y} ( k ) ) + f ( ∇ {O}_{y}^{y} ( k ) ) \\ {L}_{min} ( k ) = \frac{1}{N} \sum ( 1 - SSIM ( {I}_{i} , {I}_{1}^{′} ) ) \\ {L}_{1} ( k ) = {L}_{pix} ( k ) + {λ}_{1} {L}_{s} ( k ) + {λ}_{2} {L}_{ssim} ( k ) \\ {L}_{1} = {\sum }_{k = 1}^{3} {L}_{1} ( k ) \\ f ( x ) = {( {x}^{2} + {ɛ}^{2} )}^{2} \qquad [ Equations 1 ]$$

In Equations 1, Lpix(k) is a loss function of pixels and may mean an average of differences in pixels between an image, I₂(i+O_{i,j}^{x}(k),j+O_{i,d}^{y}(k)), which is restored by using a following frame on the basis of a predicted optical flow and an original image, I₁(i,j). Here, k is an index of each of optical flows obtained from the first deep neural network and may be k∈{1,2,3}.

Lₛ(k) is a loss function of a smoothness constraint of an optical flow. That is, as Lₛ (k) becomes smaller, a change amount of difference from surrounding pixel values may become smaller.

Meanwhile, Lₛₛᵢₘ(k) is a term for increasing a structural similarity (SSIM) index between the restored image and the original image, a maximum value of the SSIM index is one, and as the SSIM index becomes higher, the restored image and the original image become structurally similar to each other. Here, SSIM( ) is a standard structural similarity function.

L₁(k) refers to a weighted sum of losses described above, which will be applied to optical flow prediction for the index k. Finally, L₁ refers to a total loss obtained from optical flow predictions and applied to an entire network. That is, L₁ is an objective function of the first deep neural network and may be used after the first deep neural network learns that a value of L₁ becomes minimum in the method of detecting a moving object according to the present invention.

Meanwhile, f(x) is a Charbonnier penalty, and λ₁, λ₂, and ε are arbitrary constants.

Here, O^{x}(k) is an optical flow in an x-axis direction obtained through an output layer k of the optical flow prediction deep neural network, and O^{y}(k) is an optical flow in a y-axis direction obtained through the output layer k of the optical flow prediction deep neural network.

The optical flow prediction deep neural network 100, which receives a plurality of sports image clips as an input, outputs an optical flow as a result of a processing or prediction thereof.

The optical flow deep neural network described with reference to the embodiment of FIG. 4 has an inference speed in the following Table 1 from an experiment performed with apparatuses having the same hardware performance. The value means that speed performance thereof is ten times that of a case in which a conventional optical flow calculation method is used.

TABLE 1

| Section | Inference Time (ms) |
|---|---|
| CPU | 22.7/frame |
| Network | 2.28/frame |

The experiment is performed using Intel® Core™ i7-8700K CPU @ 3.70 GHz as a central processing unit (CPU) and NVIDIA TITAN Xp as a graphics processing unit (GPU). Here, in a case in which an optical flow prediction deep neural network having another configuration is used, a speed thereof may increase or decrease.

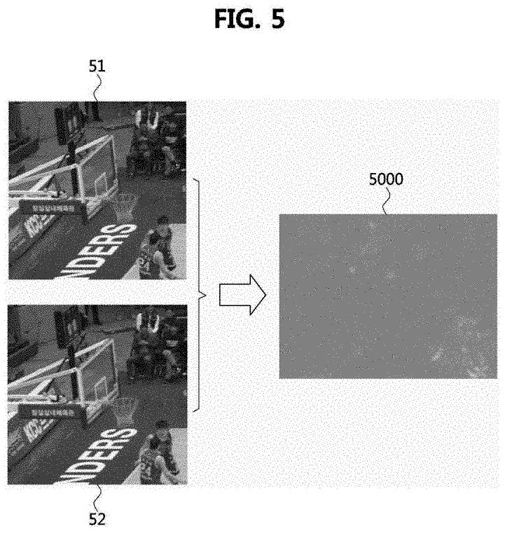

FIG. 5 is a view illustrating one example of an optical flow image according to the present invention.

Referring to FIG. 5, among input frames in an actual experiment, an image 51 corresponds to a frame 0 and an image 52 corresponds to a frame 1. An optical flow image obtained from two images through optical flow prediction is an image 5000 illustrated in FIG. 5. The image 5000 is an image showing an optical flow and may not have a color value but only a luminance value. The image 5000 is provided as an input of the ball detection deep neural network which will be described below.

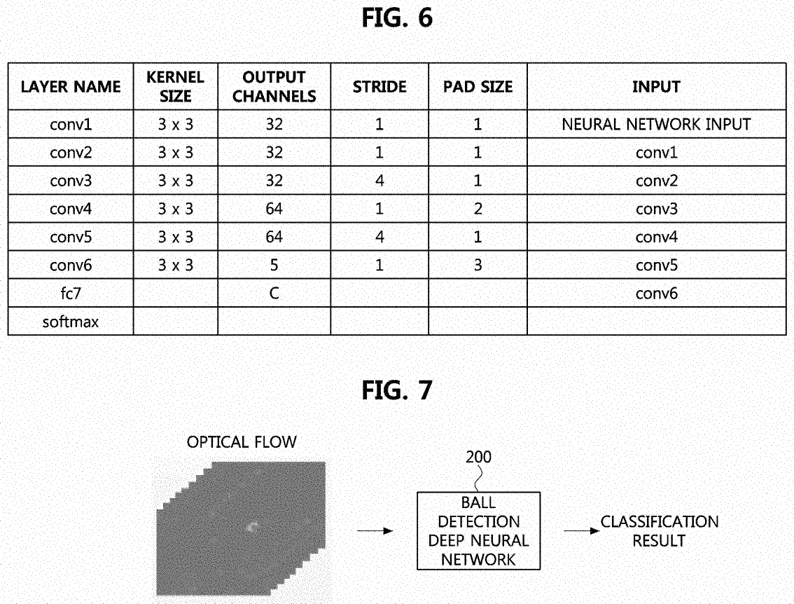

FIG. 6 is a table showing a configuration of the ball detection deep neural network according to one embodiment of the present invention.

Referring to FIG. 6, conv*, that is, conv1, conv2, conv3, or conv4, is a name of a convolutional layer, and fc* (for example, fc7) refers to a fully connected layer. In addition, softmax refers to a softmax layer, that is, an output of the network. In addition, C refers to the number of labels, and LeakyReLU(slope=0.1) may be used as a non-linearity function of the convolutional layer.

Here, a softmax function is a function in which input values are normalized into output values in the range of zero to one, and the softmax function has a characteristic in which a sum of the output values is always one. In the deep neural network, the number of outputs may be generated to be the same as the number of classes desired to be classified by using the softmax function, and the class to which a highest output value is assigned may be used as the highest probability.

The configuration of the ball detection deep neural network illustrated in FIG. 6 is only one embodiment, and the configuration of the ball detection deep neural network according to the present invention is not limited thereto. Based on the designed ball detection deep neural network, the ball detection deep neural network learns through a method in which, for example, an optical flow image and whether a ball exists in the corresponding optical flow image or a position of the ball therein are labeled and used as an input of the ball detection deep neural network.

FIG. 7 is a view illustrating an input and an output of the ball detection deep neural network for learning according to one embodiment of the present invention.

A learning process of the ball detection deep neural network will be described with reference to FIG. 7.

First, an image clip including T frames and a label corresponding thereto are loaded. The optical flow prediction deep neural network which is completely trained about the corresponding image clip as described using FIG. 4 is used to generate an optical flow image. The ball detection deep neural network 200 is designed to receive the generated optical flow image as an input and output a label of a corresponding optical flow and performs learning through back propagation. Here, the back propagation may be expressed as the following Equation 2.

L₂=CE(z(O),l_{gt}) [Equation 2]

In Equation 2, L₂ is a loss function applied to the second deep neural network according to the present invention and is an objective function of the second deep neural network. CE is a cross-entropy function and may be expressed as the following Equation 3. In addition, z(O^{x}(3), O^{y}(3)) is a label in which Oₓ(3) and O^{y}(3) are received as input and classified by the ball detection deep neural network, and l_{gt} is data in which a base value is labeled.

CE(p,m)=−Σₗp(xᵢ)log(m(xᵢ)) [Equation 3]

Although it is described that the ball detection deep neural network operates according to the embodiment of FIG. 6, the configuration of the deep neural network according to the present invention is not limited to the corresponding configuration. That is, a configuration of the deep neural network may be different from the embodiment illustrated in FIG. 6, or ball detection may also be performed in an optical flow prediction image by using a different method such as a feature extraction technique instead of the deep neural network.

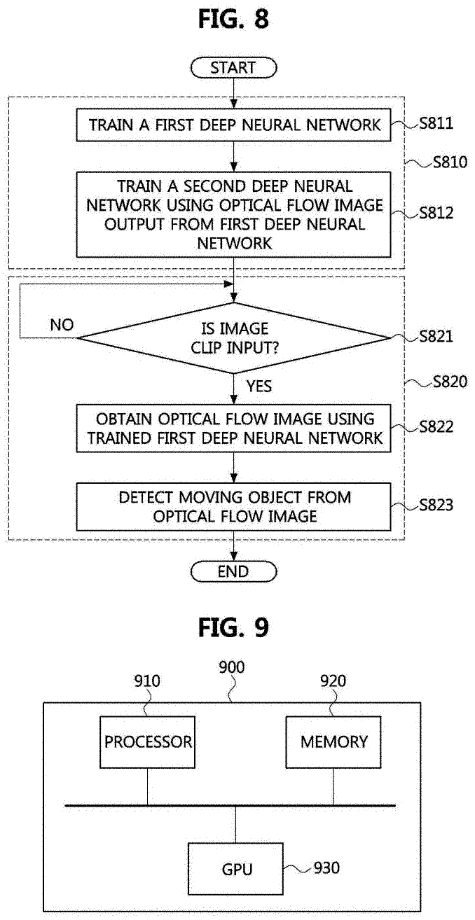

FIG. 8 is a flowchart of the method of detecting a moving object according to one embodiment of the present invention.

The method of detecting a moving object according to one embodiment of the present invention may mainly include training a deep neural network (S810) and detecting a moving object using the trained deep neural network (S820). Since the training of the deep neural network and the detecting of the moving object may be generally performed at a considerable time interval, and the trained deep neural network is used to detect the moving object, it is preferable that the training of the deep neural network be performed before the detecting of the moving object.

The training of the deep neural network (S810) may include training a first deep neural network (S811) and training a second deep neural network using an optical flow image output by the first deep neural network (S812).

Here, the training of the first deep neural network (S811) may include predicting an optical flow using a difference between a first group image including a plurality of frames and a second group image including a plurality of frames which directly follow the frames in the first group image over time.

The training of the first deep neural network (S811) may include: the predicting of the optical flow using the difference between the first group image including the plurality of frames and the second group image including the plurality of frames which directly follow the frames in the first group image over time; calculating an error value by comparing the predicted optical flow and an actual optical flow; and training the optical flow prediction deep neural network by propagating the error value back and performing a gradient descent.

The detecting of the moving object using the trained deep neural network (S820) is performed through obtaining the optical flow image using the trained first deep neural network (S822) for an input image clip (S821) and detecting the moving object from the optical flow image using the trained second deep neural network (S823).

FIG. 9 is a block diagram illustrating the apparatus for detecting a moving object according to one embodiment of the present invention.

The apparatus according to one embodiment of the present invention includes a processor 910 and a memory 920 configured to store at least one command executed by the processor and a result of a command execution. In addition, the apparatus for detecting a moving object according to one embodiment of the present invention may further include a GPU 930 in addition to the processor 910 because parallel processing is a feature of utilization of the deep neural network.

Here, at least one command may include: a command for predicting an optical flow in an input image clip using the first deep neural network trained to predict an optical flow in an image clip including a plurality of frames; a command for obtaining an optical flow image which reflects a result of an optical flow prediction; and a command for detecting a moving object in the image clip on the basis of the optical flow image using the second deep neural network trained by using the first deep neural network.

The image clip may include a sports image clip including a plurality of frames.

The optical flow may include optical flows in two directions (for example, x and y directions) that is perpendicular to each other.

The first deep neural network may be trained through calculating an error value between a predicted optical flow and a calculated actual optical flow, propagating the error value back, and performing a gradient descent.

The predicting of the optical flow in the input image clip may include the predicting of the optical flow using the difference between the first group image including the plurality of frames and the second group image including the plurality of frames which follow the frames in the first group image over time by using the first deep neural network.

The first deep neural network may be trained through: the predicting of the optical flow using the difference between the first group image including the plurality of frames and the second group image including the plurality of frames which follow the frames in the first group image; the calculating of the error value by comparing the predicted optical flow and the actual optical flow; and the training of the optical flow prediction deep neural network by propagating the error value back and performing the gradient descent.

The second deep neural network may be trained through labeling whether the ball exists in an optical flow image or a position of the ball therein and using the label as an input of the second deep neural network.

The first deep neural network may have a loss function to be applied to the first deep neural network as an objective function and may be trained such that the objective function has a minimum value.

The second deep neural network may have a loss function to be applied to the second deep neural network as an objective function and may be trained such that the objective function has a minimum value.

The present invention described according to the embodiments uses the deep neural networks and predicts an optical flow in an image at a high speed to detect a ball, unlike a conventional technology in which a sports image is directly analyzed to detect a ball. During the detection operation, optical flow prediction data is obtained as an intermediate output, and since the obtained data is generated through deep neural networks, the obtained data may be similar to a result calculated by using a formula of an actual optical flow.

The apparatus for detecting a moving object according to the present invention may include an image processing apparatus or may be included in an image processing apparatus. Here, the image processing apparatus may be a server terminal, such as a personal computer (PC), a notebook computer, a personal digital assistant (PDA), a portable multimedia player (PMP), a PlayStation Portable (PSP), a wireless communication terminal, a smart phone, a television set (TV) application server, or a service server, or a user terminal such as various devices or the like, or may mean various apparatuses including a communication device such as a communication modem for performing communication with wired or wireless networks, a memory for storing various programs and data for detecting a moving object, and a microprocessor for executing programs to perform calculation and control.

The operation of the method according to the embodiment of the present invention may be implemented using programs or codes, which may be read by a computer, in recording media capable of being read by the computer. The recording media capable of being read by the computer includes any kind of recording device in which data is capable of being read by a computer system. In addition, the recording media capable of being read by the computer may be distributed within the computer system connected through a network so that the programs and codes capable of being read the computer may be stored and executed in a distributed manner.

In addition, the recording media capable of being read by the computer may include hardware devices such as a read-only memory (ROM), a random-access memory (RAM), and a flash memory, which are particularly configured to store and execute program commands. The program commands may include high language codes executed by the computer using an interpreter and the like, as well as machine codes generated by a compiler.

Some aspects of the present invention have been described in a context of an apparatus but may be described in a context of a corresponding method. Here, a block or apparatus corresponds to operations of the method or characteristics of the operations of the method. Similarly, aspects described in the context of the method may be described as a corresponding block or item, or a feature of a corresponding apparatus. Some or all operations of the method may be performed by (or using) a hardware device such as a microprocessor, a computer capable of programing, or an electronic circuit. In some embodiments, at least one operation among the most important operations of the method may be performed by such an apparatus.

In the embodiments, a logic device (for example, a field programmable gate array) capable of being programed may be used in order to perform some or all functions of the methods described in this specification. In the embodiments, the field programmable gate array may operate in conjunction with a microprocessor for performing one of the methods described in this specification. Generally, the methods may be performed by a hardware device.

According to the embodiments of the present invention, when ball recognition is attempted by a method of using an optical flow, the optical flow is not simply calculated when used. After a learning process is performed to predict the optical flow by using a deep neural network, the ball is recognized from the predicted optical flow through the learned deep neural network, and thus the optical flow can be predicted at a high speed, and the ball can be accurately and quickly recognized.

While the example embodiments of the present invention have been described in detail, it should be understood that various changes and modifications may be made by those skilled in the art without departing from the spirit and scope of the appended claims.

What is claimed is:

1. A method of detecting a moving object, comprising:
predicting an optical flow in an input image clip using a first deep neural network which is trained to predict an optical flow in an image clip including a plurality of frames;
obtaining an optical flow image which reflects a result of the optical flow prediction; and
detecting a moving object in the image clip on the basis of the optical flow image using a second deep neural network which is trained by using the first deep neural network.

2. The method of claim 1, wherein the image clip includes a sports image clip including a plurality of frames.

3. The method of claim 1, wherein the optical flow includes optical flows in two directions which are orthogonal to each other.

4. The method of claim 1, wherein the first deep neural network is trained through:
calculating an error value between the predicted optical flow and a calculated actual optical flow;
propagating the error value back; and
performing a gradient descent.

5. The method of claim 1, wherein the predicting of the optical flow in the image clip includes predicting the optical flow using a difference between a first group image including a plurality of frames and a second group image including a plurality of frames, each of which directly follows a corresponding frame of the first group image over time, by using the first deep neural network.

6. The method of claim 1, wherein the first deep neural network is trained through:
predicting the optical flow using a difference between a first group image including a plurality of frames and a second group image including a plurality of frames, each of which directly follows a corresponding frame in the first group image;
calculating an error value by comparing the predicted optical flow and an actual optical flow; and
training an optical flow prediction deep neural network through propagating the error value back and performing a gradient descent.

7. The method of claim 1, wherein the second deep neural network is trained through:
labeling whether a ball exists in the optical flow image or a position of the ball therein; and
using the label as an input of the second deep neural network.

8. The method of claim 1, wherein the first deep neural network is trained such that the objective function has a minimum value by using a loss function to be applied to the first deep neural network as an objective function.

9. The method of claim 1, wherein the second deep neural network is trained such that the objective function has a minimum value by using a loss function to be applied to the second deep neural network as an objective function.

10. The method of claim 1, wherein the first deep neural network is formed by learning weights of edges between nodes of at least one hidden layer in the first deep neural network.

11. An apparatus for detecting a moving object, comprising:
a processor; and
a memory configured to store at least one command executed by the processor, wherein the at least one command includes:
a command for predicting an optical flow in an input image clip using a first deep neural network trained to predict an optical flow in an image clip including a plurality of frames;
a command for obtaining an optical flow image which reflects a result of the optical flow prediction; and
a command for detecting a moving object in the image clip on the basis of the optical flow image using a second deep neural network which is trained by using the first deep neural network.

12. The apparatus of claim 11, wherein the image clip includes a sports image clip including a plurality of frames.

13. The apparatus of claim 11, wherein the optical flow includes optical flows in two directions which are orthogonal to each other.

14. The apparatus of claim 11, wherein the first deep neural network is trained through:
calculating an error value between the predicted optical flow and a calculated actual optical flow;
propagating the error value back; and
performing a gradient descent.

15. The apparatus of claim 11, wherein the command to predict the optical flow in the input image clip includes a command for predicting the optical flow using a difference between a first group image including a plurality of frames and a second group image including a plurality of frames, each of which directly follows a corresponding frame of the first group image over time by using the first deep neural network.

16. The apparatus of claim 11, wherein the first deep neural network is trained through:
predicting the optical flow using a difference between a first group image including a plurality of frames and a second group image including a plurality of frames, each of which directly follows a corresponding frame of the first group image;
calculating an error value by comparing the predicted optical flow and an actual optical flow; and
training the optical flow prediction deep neural network through propagating the error value and performing a gradient descent.

17. The apparatus of claim 11, wherein the second deep neural network is trained through:
labeling whether a ball exists in the optical flow image or a position of the ball therein; and
using the label as an input of the second deep neural network.

18. The apparatus of claim 11, wherein the first deep neural network is trained such that the objective function has a minimum value by using a loss function to be applied to the first deep neural network as an objective function.

19. The apparatus of claim 11, wherein the second deep neural network is trained such that the objective function has a minimum value by using a loss function to be applied to the second deep neural network as an objective function.

20. The apparatus of claim 11, wherein the first deep neural network is formed by learning weights of edges between nodes of at least one hidden layer in the first deep neural network.
